(19) United States
(12) Patent Application Publication
(10) Pub. No.: US 2016/0253650 A1
(43) Pub. Date: Sep. 1, 2016

(54) METHODS AND SYSTEMS FOR PROVIDING MOBILE SERVICES BETWEEN MOBILE NETWORK PROVIDERS

(71) Applicant: TONE MOBILE LLC, New York, NY (US)

(72) Inventor: Blake Cohen, New York, NY (US)

(21) Appl. No.: 15/055,301

(22) Filed: Feb. 26, 2016

Related U.S. Application Data
(60) Provisional application No. 62/126,600, filed on Feb. 28, 2015.

(51) Int. Cl. G06Q 20/32; G06Q 20/42; G06Q 20/40; G06Q 20/10

(52) U.S. Cl. CPC G06Q 20/322; G06Q 20/10; G06Q 20/42; G06Q 20/407

(57) ABSTRACT

A method for conducting a transaction between two parties includes receiving, from a first mobile device, a first identifier identifying a first party to a transaction for a product. The method includes receiving, from the first mobile device, a transaction request associated with the first identifier including a product identifier, a price indicator, and a second identifier associated with a second mobile device and identifies a second party to the transaction. The first and second mobile devices operate via different mobile network operators. The method includes transmitting, to the second mobile device, a request for confirmation of the transaction including the product identifier and the price indicator. In response, the method includes determining whether an account associated with the first identifier includes sufficient funds, and transferring an amount from the account associated with the first identifier to an account associated with the second identifier.

### CROSS REFERENCE TO RELATED APPLICATIONS

This application claims priority to U.S. Provisional Application No. 62/126,600, filed Feb. 28, 2015. The disclosures of the referenced applications are incorporated herein by reference.

### FIELD OF INVENTION

This disclosure generally relates to mobile services, and more specifically, to automatically integrating whitelisting, payment, and commerce mobile services among mobile network operators to allow a mobile subscriber to seamlessly perform transactions outside the network of the mobile subscriber's mobile network operator.

### BACKGROUND

Traditionally, mobile device users and subscribers are charged data rates by their mobile network operator (MNO) for any data transferred to the subscriber, regardless of whether the subscriber requested the data. For example, a subscriber may be required to pay data costs for advertisement, data mining activities, “free” mobile applications, or other data transferred to the subscriber involuntarily whether or not the subscriber requested such transfer. Depending on the subscriber's data plan, these involuntarily data transfers may limit the overall data usage of the subscriber who may have a very lean data plan. Moreover, some consumers may not be able to afford mobile data service at all due to the cost of data plans.

As a courtesy to its mobile subscribers and to provide more value to its customers, a MNO may provide particular services to subscribers free of charge on their own network. For example, a MNO may allow subscribers to contact the MNO's customer service or to manage the subscriber's online account without affecting the subscriber's mobile data plan or tolling data usage, etc. Typically, these courtesy services are accessed via a uniform resource link (URL) and, in turn, the MNO may “whitelist” each URL for such services to denote that the data transferred in using such service will not count against the subscriber's data usage. As a result, the MNO may allow subscribers or even other non-subscribing customers to use any whitelisted URL without affecting the subscriber's mobile data plan, charging for data usage, etc. In other words, the MNO incurs the data transfer costs on behalf of the subscriber as a courtesy.

Additionally, in many instances MNOs can lose value added service revenues in supporting third party web apps, in maintaining legacy infrastructure models, and in implementing outdated policies that inhibit their ability to better monetize web services. As a result, some MNOs have partnered with financial institutions to provide their subscribers mobile banking services, such as subscriber to subscriber transfers, insurance payments, bill payments, and other personal financial services. However, these mobile banking services are only available for subscribers within a specific MNO's network for a particular country and currency, and not operable between subscribers or customers of two separate MNOs. For example, a subscriber may traditionally only transfer money to another subscriber within the same MNO located in the same country using one currency.

### SUMMARY

In one embodiment, the disclosure described a computer-implemented method for conducting a transaction between two parties. The method includes receiving, from a first user mobile device via a digital communication network, a first user identifier that identifies a first party of two parties to a transaction for a product. The method also includes receiving, from the first user mobile device, a transaction request associated with the first user identifier. The transaction request includes i) a product identifier that identifies a product to be transacted between the two parties, ii) a price indicator that includes the price of the product, and iii) a second user identifier that is associated with a second user mobile device and identifies a second party of the two parties to the transaction. The first user mobile device and the second user mobile device operate via different mobile network operators. The method also includes transmitting, to the second user mobile device over the digital communication network, a request for confirmation of the transaction that includes the product identifier and the price indicator. In response to receiving a confirmation from the second user mobile device, the method also includes determining whether an account associated with the first user identifier includes sufficient funds. Finally, the method includes transferring an amount from the account associated with the first user identifier to an account associated with the second user identifier if the account associated with the first user is determined to include sufficient funds.

In another embodiment, the disclosure describes a computer-implemented method for conducting a transaction. The method includes receiving, from a first user mobile device via a digital communication network, a first user identifier that identifies a first party of two parties to a transaction for a product, where the first user mobile device is connected to the digital communication network via a first mobile network operator. The method also includes receiving, from the first user mobile device via the digital communication network, a transaction request associated with the first user identifier, the transaction request including i) a product identifier that identifies a product to be transacted between the two parties, ii) a price indicator that includes the price of the product, and iii) a second user identifier that is associated with a second user mobile device and identifies a second party of the two parties to the transaction. The second user mobile device is connected to the digital communication network via a second mobile network operator that is different than the first mobile network operator. The method also includes transmitting, to the second user mobile device via the digital communication network, a request for confirmation of the transaction that includes the product identifier and the price indicator. The method includes determining that the second user mobile device has provided a confirmation of the transaction and, in response to receiving the confirmation of the transaction from the second user mobile device, determining that an account associated with the first user identifier includes sufficient funds. Finally, the method includes transferring an amount from the account associated with the first user identifier to an account associated with the second user identifier.

In another embodiment, the disclosure describes a non-transitory machine readable storage medium storing machine-executable instructions for causing a processor to perform a method for conducting a transaction between two parties. The method includes receiving, from a first user mobile device via a digital communication network, a first user identifier that identifies a first party of two parties to a transaction for a product. The method also includes receiving, from the first user mobile device, a transaction request associated with the first user identifier, the transaction request including i) a product identifier that identifies a product to be transacted between the two parties, ii) a price indicator that includes the price of the product, and iii) a second user identifier that is associated with a second user mobile device and identifies a second party of the two parties to the transaction. The first user mobile device and the second user mobile device operate via different mobile network operators. The method also includes transmitting, to the second user mobile device, a request for confirmation of the transaction that includes the product identifier and the price indicator. The method includes, in response to receiving a confirmation from the second user mobile device, determining whether an account associated with the first user identifier includes sufficient funds. Finally, the method includes transferring an amount from the account associated with the first user identifier to an account associated with the second user identifier if the account associated with the first user is determined to include sufficient funds.

### BRIEF DESCRIPTIONS OF THE DRAWINGS

FIG. 1 is a high-level block diagram of a computing environment for implementing an embodiment of a mobile service system as shown and described herein.

FIG. 2 illustrates an example routine or process flow diagram of an embodiment for creating a mobile wallet account using the mobile service system.

FIG. 3 illustrates an example routine or process flow diagram of an embodiment for processing a sales transaction from a subscriber associated with one mobile network operator to another subscriber associated with a different mobile network operator.

FIG. 4 is a flow chart illustrating an exemplary method or process for conducting a transaction between two parties via the mobile service system.

It should be understood that the drawings are exemplary only and the invention is not limited to the illustrated exemplary embodiments. Additionally, all features described or illustrated herein can be used alone or combined in various combinations to provide embodiments of the invention. The following detailed description and accompanying drawings illustrate features of various embodiments of the invention, but it should be understood that some descriptions or details of well-known features and techniques may not be included for the sake of simplicity and clarity.

### DETAILED DESCRIPTION

Embodiments of a mobile service system for conducting transactions between two parties via mobile or other devices over a digital communication network is shown and described herein. In some embodiments, the transactions can involve mobile devices that operate on different mobile network operators, are located in different countries, or between accounts that hold funds in different currencies. Using the disclosed mobile service system subscribers can transfer funds and complete transactions even if the two parties to the transaction are not in geographical areas that are covered by the same mobile network operators.

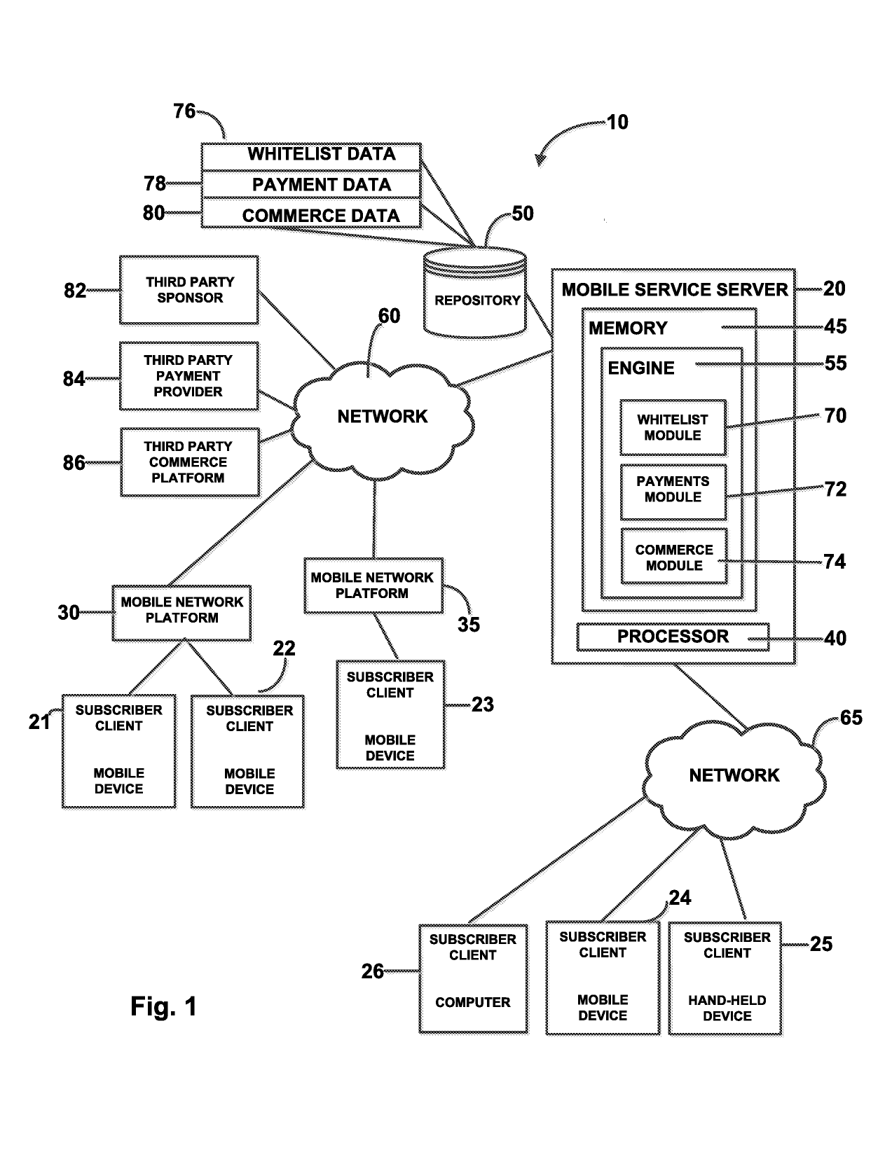

Referring to the figures, FIG. 1 is a high-level block diagram that illustrates a computing environment 10 for an embodiment of a mobile service system featuring a mobile service server 20 that may be used to allow a mobile subscriber 21-26 to access particular content without incurring data costs, or perform transactions with another subscriber that subscribes to mobile services with a different mobile network operator (MNO) 30, 35. The mobile service server 20 may be, for example, implemented in a computer having a processor 40, a memory 45, a computer readable medium or storage unit of any desired type or configuration, and commutatively coupled with a one or more repositories 50, although only one repository is shown in FIG. 1 for clarity. The memory 45 may store an engine 55, which can be configured to communicate with one or more subscriber clients 24-26 via one or more networks 65. The engine 55, in turn, can include a whitelist module 70, payments module 72, and commerce module 74. Each subscriber client 24-26 includes a processor and a computer readable memory that may execute a browser or anything other application that may request mobile service data from the mobile service server 20. Any particular subscriber client 24-26 may be connected to or may be disposed within a user interface device that may be for example, a hand-held device 25, such as a smart phone or tablet computer, a mobile device 24, such as a mobile phone, a wearable mobile device, a computer 26, such as a laptop or a desktop computer, or any other device that allows a user to interface using the network 65. Any particular subscriber client 21-26 may also be connected to or may be disposed within a subscriber client that is only communicatively coupled to a MNO 30, 35 (discussed below). While only three subscriber clients 24-26 connected to the mobile service server 20 via network 65 alone are illustrated in FIG. 1 to simplify and clarify the description, it is understood that any number of subscriber clients are supported and can be in communication with the mobile service server 20.

The mobile service system 10 also includes one or more mobile network operators (MNOs) 30, 35 that are connected to their own one or more respective subscriber clients 21-23 and to the mobile service server 20 through a digital communication network 60. The repository 50, as described above, is connected to or is disposed within the mobile service server 20 and stores content data of any type, including, for example, whitelist data 76 (such as whitelisted URLs, third party sponsors associated with the whitelisted URLs, subscriber usage logs, etc.), payment data 78 (transactional history logs of subscribers' money transfers, types of currency used, etc.), commerce data 80 (historical sales data, products sold, quantities of products sold, billing statements, etc.), and any other type of data that may be used by a mobile subscriber 21-26. Generally speaking, the data stored in the repositories 50 may be any data of any type and stored in any organizational manner including structured and unstructured data that may reside in relational and non-relational databases, or any other type of data residing in any other type of storage schema.

As illustrated in FIG. 1, the mobile services server 20 may also be connected to and may communicate with one or more third party sponsors 82, one or more third party payment providers 84, and one or more third party commerce platforms 86 through the communication network 60. Although FIG. 1 only depicts one third party sponsor 82, one third party payment provider 84, and one third party commerce platform 86, any number of party sponsors, third party payment providers, and third party commerce platforms are contemplated. The third party sponsor 82, which may be stored in a separate dedicated server, for example, may operate to store (or to create, to aggregate, etc.) advertisement data, video, text, image, audio, or any other suitable type of content data intended for a mobile subscriber 21-26 and may even communicate this content data to the repository 50 depending on different implementations. The content data may be any data generated or stored by a third party sponsor 82 of any type that pertains to, that is associated with, or that is related to content data stored in a third party sponsor database. The third party payment provider 84, which may also be stored in a separate dedicated server such as a third party payment provider server, for example, may operate to store payment data, historical transactions data, authorized user data, authentication data, or any other suitable type of payment data that facilitates in allowing a subscriber 21-26 to perform financial transactions in any desired currency with another subscriber, financial institution, business, etc. located in the same or a different country than the location or residence of the subscriber. The third party commerce platform 86, which may also be stored in a separate dedicated server such as a third party commerce platform server, for example, may operate to store and to provide commerce data that may include product images, product videos, audio recordings of the product, product or service descriptions, product or service prices, product quantities and/or availability, seller/buyer information, product or service reviews, or any other data that may be associated with buying or selling a product or service.

The communication networks 60, 65 may include, but are not limited to, any combination of a LAN, a MAN, a WAN, a mobile, a wired or wireless network, a private network, or a virtual private network. Moreover, while the communication networks 60, 65 are illustrated separately in FIG. 1 to simplify and clarify the description, it is understood that only one network or more than two networks may be used to support communications with respect to the subscriber clients 24-26 direct coupled to the mobile services server 20 and the subscriber clients 21-23 coupled to the mobile network operators 30, 35.

As indicated above, the repository 50, which may be stored in or may be separate from the mobile service server 20, may contain any type of data that may facilitate in providing sponsor content to a subscriber or may facilitate the subscriber in conducting a transaction with another party. The other party maybe be a subscriber associated with a different MNO 30, 35 than the original subscriber, a financial institution, or any other second party in a financial transaction. This data stored in the repository 50 may include, but is not limited to, whitelist data, such as a list of URLs (e.g., website link, mobile application, web-based media (images, video, audio, etc.), FTP links, etc.) associated with third party sponsors 82, such that when a subscriber 21-26 visits one of the stored whitelisted URLs (e.g., a third party sponsor's URL(s)), the data costs are incurred by the third party sponsor and not to the subscriber. For example, in one embodiment, a third party sponsor soft drink manufacturer may desire to share promotional images, videos, etc., with consumers, but does not want data charges incurred in viewing this content to deter consumers from accessing it. The soft drink manufacturer may choose to share one or more selectable (or embedded) URLs with a mobile subscriber 21-26 via a web browser, mobile app, etc. associated with or embedded in the subscriber client. Continuing this example, if the subscriber selects the provided link or engages with the mobile app that has been whitelisted, the mobile service server 20 can direct the subscriber to content provided by the soft drink manufacturer. Any data transferred to the subscriber in accessing this content will not be charged against the subscriber's account with the MNO 30, 35. Rather, in this example, the mobile service server 20 may execute a whitelist module 70 stored in the memory 45 of the mobile service server to determine a running account total for the amount of data transferred to all the subscribers whom access the third party sponsor's whitelisted URL. The running total of the sponsor's data accessed on the whitelisted URL can be consequently stored as whitelist data 76 in the repository 50. As described above, the third party sponsor 82 may store the content intended for subscribers on a third party sponsor server and/or repository, and the stored content may include rich media content, such as videos, images, audio, interactive content, etc., file-based content including portable file documents (pdf), word processing documents, image processing documents, compressed files, or any other storable asset. Any of the content may be may automatically generated or aggregated by an application and stored as application generated data.

The whitelist data 76 can also be accessed by a content editor embedded in the third party sponsor 82 system, can be modified, and can be stored back into one or more of the repositories 50. Further, a repository 50 need not be physically located within the mobile service server 20. For example, the one or more repositories 50 can be stored in external storage attached to the mobile service server 20, as shown in FIG. 1, or can be stored in a network attached storage. Additionally, some embodiments may include multiple mobile service servers 20 that connect to a single repository 50 or the repository may be stored in multiple different or separate physical data storage devices. When executed, the content editor operates to allow a user or a content manager (who may or may not be associated with the third party sponsor 82) to modify the content data stored in the one or more repositories 50, for example, to create a content data, to update content data within the one or more repositories or to associate more information, such as a metadata for tracking subscriber usage, views, clicks, etc., with the content data. However, in many cases, content data, including textual content, assets, metadata, application data, etc. may be updated by individuals or particular users associated with the third party sponsor 82 in any desired manner.

As a result of maintaining a running balance for each subscriber accessing the sponsor content associated with the whitelisted URLs, the whitelist module 70 allows subscribers to access and consume content at no cost to the subscriber 21-23. Moreover, the whitelist module 70 may track data usage for each third party sponsor 82 (or for each URL) for each MNO 30, 35 for every subscriber who accessed the sponsor URL(s) and content. The whitelist module 70 may further generate usage reports, billing reports, etc. for a particular third party sponsor 82. As an example, in one embodiment, a city's department of transportation may wish to incur the costs of its riders accessing a support or customer service website that may be associated with the department of transportation (or not associated, in other embodiments). In another exemplary embodiment, a video content stream service may wish to defray some of its customers' costs by subsidizing the data costs for those customers that desire to stream video to their mobile device. On the other hand, the sponsor may desire to directly charge the subscriber for access to the sponsor's web service.

Alternatively, the mobile service server 20 may directly access a MNO's 30, 35 whitelist module 70 or data 76 to add or update a URL on behalf of a sponsor. In an example, the mobile service server 20 may receive an electronic request to publish a new URL with one or more MNOs 30, 35 from the third party sponsor 82 via the communication network 60. The mobile service server 20 may execute the whitelist module 70 to transmit to a desired MNO 30, 35 a request to update the whitelist service of the MNO with the new URL received from the third party sponsor 82. In response, the mobile service server 20 may receive a confirmation from the MNO 30, 35 that the whitelist server of the MNO was properly updated with the new URL. The whitelist module 70 may continue transmitting whitelist URL posting requests to other MNOs 30, 35 that the third party sponsor 82 desires. Additionally, the third party sponsor 82 may request whether the data usage costs be incurred by the sponsor or to directly charge users for a premium service. In either case, the mobile service server 20 may directly track data usage associated with the particular whitelisted URL or may request or retrieve usage data from the MNO 30, 35. This determined or received data usage may be used for billing the data usage charges to the third party sponsor 30, 35 or as metrics of data usage for particular URLs (e.g., the number of view for a particular streamed television show associated with a whitelisted URL). Moreover, the mobile service server 20 may perform these tasks of tracking and determining data usage for MNOs 30, 35 in different countries, using different currencies, etc.

In some embodiments, the mobile service server 20 can execute a payments module 72 stored on the memory 45 of the mobile service server to allow a subscriber 21, 22, after creating an account and logging into the account, to seamlessly send a mobile payment from a mobile device associated with one MNO 30 to another subscriber's 23 mobile device that is associated with a different MNO 35. This mobile payment may be executed, for example, entirely from a website or mobile app associated with the mobile service server 20 by using a mobile wallet of the subscriber 21, 22 that associated with the subscriber's MNO 30 or another third party payment provider 84.

In some embodiments, the mobile service server 20 may execute a commerce module 74 stored on the memory 45 of the mobile service server 20 to allow subscribers who are users of the mobile service server to post items, products, or services for sale for other subscribers or users that may not be affiliated with the mobile service server. After logging into a previously created account, a subscriber may browse products posted by other sellers, select a particular product, and buy the product by using a financial service engine associated with the subscriber's MNO 30, 35 or another third party payment provider 84. After the payment is authorized by the third party payment provider 84, the mobile service server 20 can confirm the order and send an order confirmation notification to the buyer.

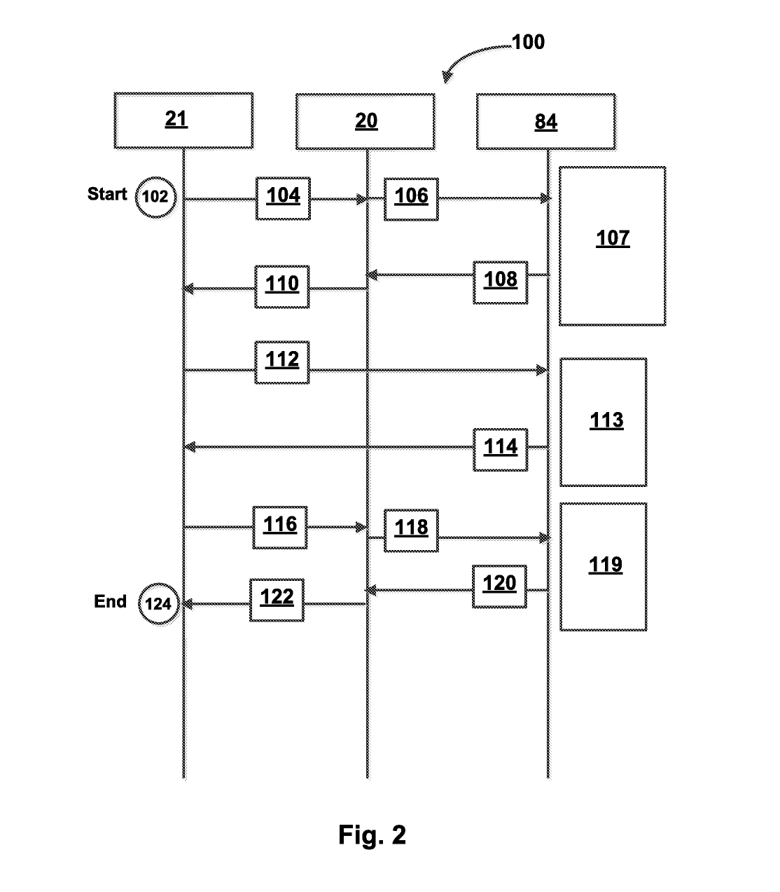

FIG. 2 illustrates an embodiment of a routine or a process flow diagram 100 that may be implemented by the engine 55 of the mobile service server 20 of FIG. 1 to allow a subscriber to create a mobile wallet account and to verify the subscriber via the subscriber's mobile device, phone, web browser, etc. After starting at 102, a subscriber 21 uses the mobile or other device to send a request to create a mobile wallet account to the mobile service server 20 at 104. The particular subscriber 21 can be associated with a particular MNO 30. In some embodiments, the request includes identifying information for the subscriber 21, such as email address, handle, phone number, account number, etc. Although FIG. 2 shows the subscriber client 21 from FIG. 1 using a mobile device, it is contemplated that other types of users, such as subscribers 22-26, with other types of devices could be used as well. Upon receiving the request, the engine 55 executes a payments module 72 to process the received request. In response, at 106, the payments module 72 uses the received information (e.g., email address, handle, phone number, etc.) to create and send a request to the payment provider. In the embodiment illustrated in FIG. 2, the payment provider may be a third party payment provider 84, such as a financial institution, internet-based money transfer or payment provider, etc., or may be a digital wallet service offered by the subscriber's MNO or any other suitable payment system. In the illustrated embodiment, the third party payment provider 84 executes a wallet token application program interface (API) 107 to process the request from the payment module 72 in the mobile service server 20, but it is contemplated that the third party payment provider can implement other types of suitable processing mechanisms. In any event, the payment provider 84 matches the credentials for the subscriber and responds, at 108, with a request token and a redirect URL to the mobile service server 20. At 110, the mobile service server forwards or redirects the request token or redirect URL to the subscriber's mobile device 21.

At 112, in response to receiving the request token and redirect URL, the subscriber 21 can perform authentication and/or authorization procedures with the payment provider 84. In the illustrated embodiment, for security reasons, the subscriber 21 may directly interact with the payment provider 84; however, in some embodiments, the mobile service server 20 can direct such authentication proceedings. The authentication and/or authorization interaction can include the subscriber 21 logging onto a permissions page hosted by the payment provider using login and/or password information specific to that subscriber, a digital certificate containing authenticated subscriber-specific information, or any other suitable form of identity authentication. The third party payment provider 84 executes a permissions page 113 that receives and processes the login/password or other credential information from the subscriber 21. If the login/password or other credentials is accepted by the permissions page 113 of the third party payment provider 84, the payment provider can provide a response at 114 that includes a payment handle including an access token and token secret. The subscriber 21 can receive the payment handle via its mobile device and, at 116, forward the payment handle on to the payments module 72 at the mobile service server 20. In the illustrated embodiment, at 118, the payments module 72 of the mobile service server 20 then transmits the payment handle along with a request for account information associated with the subscriber 21. In some embodiments, a wallet merchant API 119 at the payment provider 84 receives the forwarded payment handle from the mobile service server 20 and, at 120, in response, the payment provider 84 may transmit the account information to the payments module 72 in the mobile service server. The payments module 72 may then transmit, at 122, the account information and other transactional information to the subscriber 21 via the subscriber's mobile device. At 124, the subscriber mobile device 21 receives the account information, completing the creation and verification of the subscriber's mobile wallet account with the third party payment provider 84. In some embodiments, the payments module 72 can direct the subscriber 21 to view account information, such as account balances, transaction histories, etc.

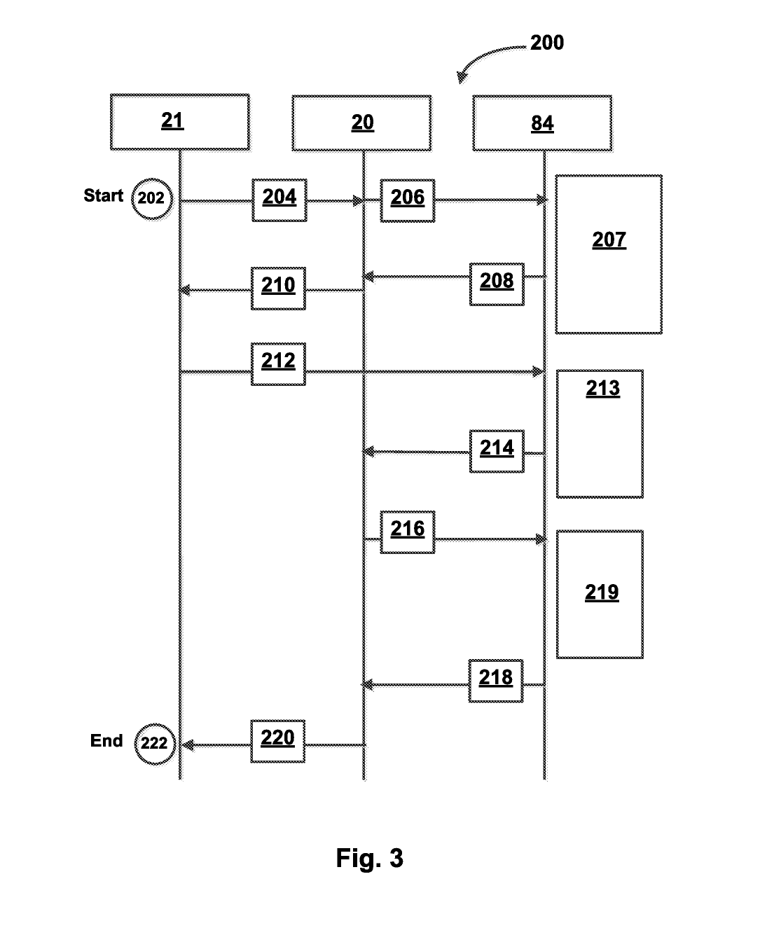

FIG. 3 illustrates a routine or a process flow diagram 200 that may be implemented by the engine 55 of FIG. 1 to allow a subscriber 21 to purchase a product and to verify the subscriber via the subscriber's mobile device, phone, web browser, etc. In some embodiments, the subscriber 21 making a purchase can be associated with a first MNO 30, and the seller can be another subscriber 23 associated with a second MNO 35. After starting at 202, at 204 a subscriber 21 uses its mobile device to send a request to purchase a product or service. In some embodiments, the subscriber 21 may have already created a mobile wallet account using a process such as that shown and described with respect to flow diagram 100 in FIG. 2. Upon receiving this request, the mobile service server 20 executes a commerce module 74 (from FIG. 1) to process the request. The particular subscriber 21 can be associated with a particular MNO 30. Additionally, although FIG. 3 shows the subscriber client 21 from FIG. 1 using a mobile device, it is contemplated that other types of users, such as subscribers 22-26, with other types of devices could be used as well. The request sent to the mobile service server 20 may include account information associated with the subscriber 21 and product information, such as a SKU number, a quantity number, a price, and/or any other desired or product identifying information. In response, the commerce module 74 uses the received account information to create and send an authorization URL request to the payment provider 84 at 206. The payment provider may be a third party payment provider 84, such as a financial institution, internet-based money transfer or payment provider, etc., or may be a digital wallet service offered by the subscriber's MNO or any other suitable payment system. Additionally, in the illustrated embodiment, the third party payment provider 84 can execute a wallet payments application program interface (API) 207 to process the request from the payment module 72 in the mobile service server 20, but it is contemplated that the third party payment provider can implement other types of suitable processing mechanisms. The payment provider 84 matches the credentials for the subscriber 21 and responds, at 208, to the mobile service server 20 with an authorization URL. The mobile service server 20 may then forward the authorization URL to the subscriber's 21 mobile device at 210. In some embodiments, the mobile service server 20 may determine whether an account associated with the subscriber is sufficiently funded to complete the requested transaction.

At 212, in response to receiving the authorization URL, the subscriber 21 can follow the authorization URL at 212 to navigate to an authorize payment page 213 of the third party payment provider 84 to provide authorization and/or identifying information. In the illustrated embodiment, for security reasons, the subscriber 21 may directly interact with the payment provider 84; however, in some embodiments, the mobile service server 20 can direct such authentication proceedings. At 214, the authorize payment page 213 of the payment provider 84 can transmit an authorization result and a unique transaction identifier to the commerce module 74 of the mobile service server 20. In some embodiments, the authorization result can include reporting a funds level of an account associated with the subscriber, by which the commerce module can determine whether the funds are sufficient for the requested transaction. It is contemplated that the funds held in such an account can be kept in any currency, and are exchangeable across currencies. In some embodiments, it is also contemplated that the subscriber's account information is held in the mobile service server 20 to be accessed by the commerce module 74 or payments module 72, or held in the repository 50 as commerce data 80 or payment data 78.

The commerce module 74 may, in turn, respond to the payment provider 84 at 216 by requesting transaction details based on the authorization result and the unique transaction identifier received from the payment provider. In some embodiments, the payment provider 84 may launch a wallet merchant API 219 that receives the transaction details request from the commerce module 74. The wallet merchant API 219 can then validate the transaction information and, at 218, transmit the requested transaction information to the commerce module 74. In some embodiments, the amount of funds available in an account associated with the subscriber 21 can be checked by the wallet merchant API, and reported to the commerce module 74. In some embodiments, the commerce module 74 can send a request to the seller for confirmation of the transaction, which can include a product identifier, a price, a product quantity, etc. It is also contemplated that, in some embodiments, the seller of the product can initiate the transaction, in which case the seller's mobile device would be communicating with the mobile service server 20 to provide the transaction information, and the mobile service server would request confirmation from the buyer. In response to receiving the transaction information from the payment provider 84, the commerce module 74 may, at 220, cause the subscriber 21 to be redirected to the order page to show that the purchase has been confirmed. The commerce module 74 may additionally send a notification to the seller of the purchased item. Further, in some embodiments, the mobile service server 20 may direct the seller (or otherwise second user or subscriber) to an order page to show the result of the transaction. A third party system may additionally offer retail services, such as inventory management, foreign currency exchange, etc. In one exemplary embodiment of the process shown in FIG. 3 and described herein, the mobile service system 10 allows a customer based in the United States using an online money transfer service to transfer money denoted in United States dollars to a subscriber 21 using a MNO that is based in the Philippines with the money deposited being denoted in pesos.

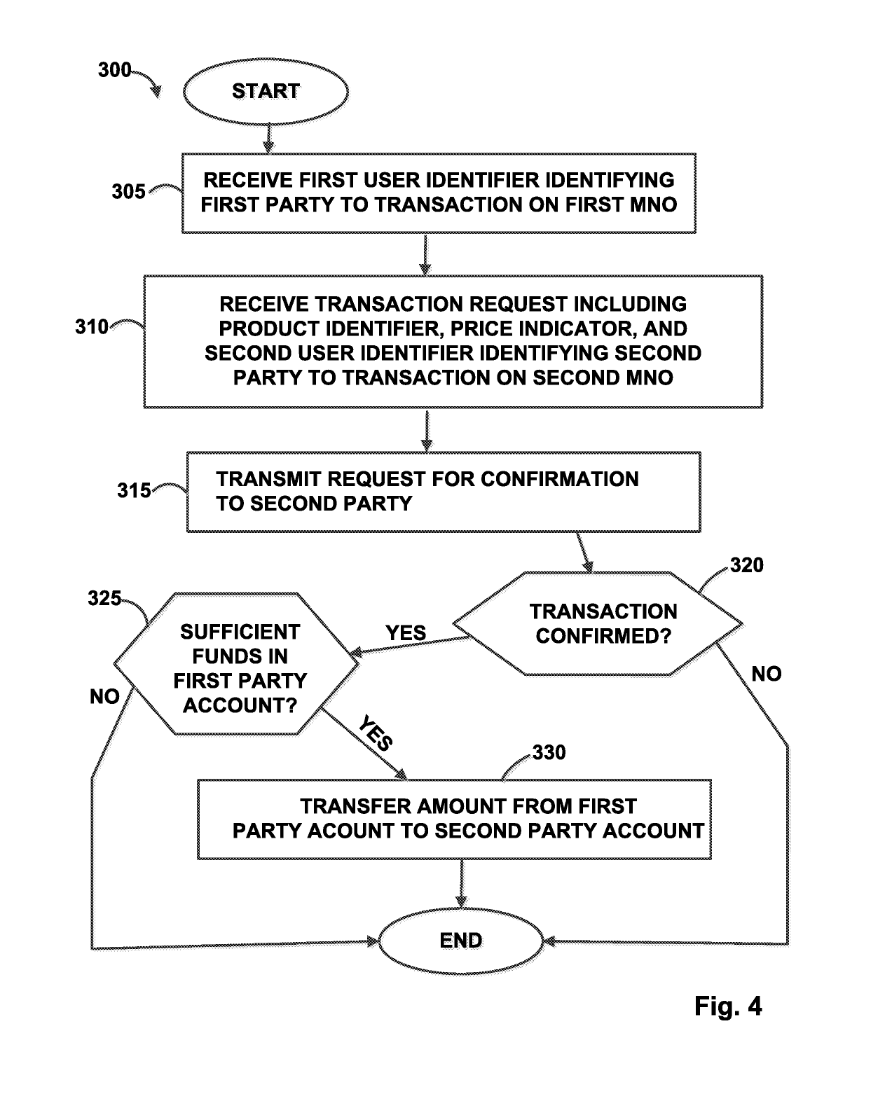

FIG. 4 is a flow chart illustrating an embodiment of a process or method 300 of using the mobile service system 10 for conducting a transaction between two parties with devices that are not necessarily using the same MNO or carrier network. At 305, the mobile service server 20 receives a first user identifier that identifies a first party of two or more parties to a transaction for a product. The first user identifier can be sent from a first user mobile device (such as mobile device of subscriber client 21 in FIG. 1) via a digital communication network, such as network 60 shown in FIG. 1. The first mobile device can be connected to the digital communication network via a first MNO, such as MNO 30 in FIG. 1. At 310, the mobile service server 20 receives, from the first user mobile device, a transaction request associated with the first user identifier. The transaction request can include, among other things, a product identifier that identifies the product or products involved in the transaction, a quantity identifier indicating the amount or size of the product to be involved in the transaction, a price indicator that indicates the price of the product or the price per unit of the product, a timing identifier indicating the date or time of the transaction is to occur, and a second user identifier. The second user identifier can be associated with a second user mobile device (such the mobile device of subscriber client 23 in FIG. 1) via the digital communications network 60. The second mobile device can be connected to the digital communication network 60 via a second MNO, such as MNO 35 in FIG. 1. In other embodiments, the first and second user mobile devices can be connected to the network 60 via the same MNO (such as mobile devices 21 and 22 connected via MNO 30 in FIG. 1). At 315, the mobile service server 20 transmits, to the second user mobile device, a request for confirmation of the transaction. The transaction confirmation can include, among other things, the product identifier, the price indicator, the quantity indicator, the first user identifier, and the timing indicator. The second user has the option of confirming or denying the request for confirmation via the second user mobile device, and transmitting the response to the mobile service server 20 via the network 60.

At 320, the mobile service server 20 determines whether the transaction has been confirmed by the second user from the second user mobile device. If no confirmation is received within a predetermined amount of time or if a negative response is received from the second user mobile device, the transaction is cancelled. In some embodiments, the mobile service server 20 can transmit a cancellation or failed transaction message to the first user mobile device. If the mobile service server 20 receives a confirmation of the transaction from the second user mobile device, the mobile service server 20, at 325, can determine whether an account associated with the first user identifier includes sufficient funds to complete the particular transaction requested. In some embodiments, the funds amount determination is made by requesting appropriate account information via the network 60 from a third party payment provider such as third party payment provider 84 shown in FIG. 1. In other embodiments, the mobile service server 20 may include account information associated with its subscribers in the memory 45, within the commerce module 74 or payments module 72, or stored in the repository 50. If the mobile service server 20 determines that the account associated with the first user identifier does not include sufficient funds for the transaction, the transaction is cancelled. If the transaction is cancelled, in some embodiments, the mobile service server 20 can transmit a message to the first user mobile device indicating that sufficient funds to complete the transaction were not available. In some embodiments, the mobile service serve 20 may provide an option to increase the funds available in the account associated with the first user identifier. In some embodiments, the mobile service server 20 will also transmit a message to the second user mobile device indicating that the transaction is cancelled. If, at 325 the mobile service server 20 determines that sufficient funds are available in the account associated with the first user identifier, at 330, the mobile service server 20 will cause the appropriate amount of funds to be transferred from the account associated with the first user identifier to an account associated with the second user identifier. In some embodiments, mobile service server 20 can request that a third party payment provider (such as third party payment provider 84) transfer the funds from one account to the other. The mobile service server 20 can then transmit confirmation messages to both the first user mobile device and the second user mobile device indicating that the transaction is complete. It is contemplated that, in some embodiments, the first user mobile device and the second user mobile device could be geographically located in different countries working under different currencies, or that the accounts associated with the first and second user identifiers can be held in different types of currencies.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, may comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Still further, the figures depict preferred embodiments of an mobile service system for purposes of illustration only. One skilled in the art will readily recognize from the foregoing discussion that alternative embodiments of the structures and methods illustrated herein may be employed without departing from the principles described herein. Thus, upon reading this disclosure, those of skill in the art will appreciate still additional alternative structural and functional designs for a system and a process for automatically extracting, transforming, and loading content data through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for conducting a transaction between two parties, the method comprising:
receiving, from a first user mobile device via a digital communication network, a first user identifier that identifies a first party of two parties to a transaction for a product;
receiving, from the first user mobile device, a transaction request associated with the first user identifier, the transaction request including i) a product identifier that identifies a product to be transacted between the two parties, ii) a price indicator that includes the price of the product, and iii) a second user identifier that is associated with a second user mobile device and identifies a second party of the two parties to the transaction, wherein the first user mobile device and the second user mobile device operate via different mobile network operators;
transmitting, to the second user mobile device over the digital communication network, a request for confirmation of the transaction that includes the product identifier and the price indicator;
in response to receiving a confirmation from the second user mobile device, determining whether an account associated with the first user identifier includes sufficient funds; and
transferring an amount from the account associated with the first user identifier to an account associated with the second user identifier if the account associated with the first user is determined to include sufficient funds.

2. The method of claim 1, wherein the transaction request further includes a quantity identifier associated with the transaction.

3. The method of claim 1, wherein the first user mobile device is disposed in a different country than the second user mobile device.

4. The method of claim 1, wherein determining whether an account associated with the first user identifier includes sufficient funds further comprises:
requesting, via the digital communication network, confirmation from a third party payment provider that the account associated with the first user identifier includes sufficient funds and;
receiving confirmation from the third party payment provider that the account associated with the first user identifier includes sufficient funds.

5. The method of claim 4, further comprising requesting, via the digital communication network, that the third party payment provider transfer funds from the account associated with the first user identifier to the account associated with the second user identifier.

6. The method of claim 1, further comprising transmitting to the first user mobile device, via the digital communication network, a message indicating that the transaction is cancelled if the account associated with the first user is determined not to include sufficient funds.

7. The method of claim 1, further comprising transmitting to the first user device, via the digital communication network, a transaction confirmation to the first user mobile device.

8. The method of claim 1, further comprising transmitting to the first user mobile device, via the digital communication network, a message indicating that the transaction is cancelled if no confirmation is received within a predetermined time.

9. The method of claim 1, wherein the first user mobile device is connected to the digital communication network via a first mobile network operator and the second user mobile device is connected to the digital communication network via a second mobile network operator.

10. A computer-implemented method for conducting a transaction, the method comprising:
receiving, from a first user mobile device via a digital communication network, a first user identifier that identifies a first party of two parties to a transaction for a product, wherein the first user mobile device is connected to the digital communication network via a first mobile network operator;
receiving, from the first user mobile device via the digital communication network, a transaction request associated with the first user identifier, the transaction request including i) a product identifier that identifies a product to be transacted between the two parties, ii) a price indicator that includes the price of the product, and iii) a second user identifier that is associated with a second user mobile device and identifies a second party of the two parties to the transaction, wherein the second user mobile device is connected to the digital communication network via a second mobile network operator that is different than the first mobile network operator;
transmitting, to the second user mobile device via the digital communication network, a request for confirmation of the transaction that includes the product identifier and the price indicator;
determining that the second user mobile device has provided a confirmation of the transaction;
in response to receiving the confirmation of the transaction from the second user mobile device, determining that an account associated with the first user identifier includes sufficient funds; and
transferring an amount from the account associated with the first user identifier to an account associated with the second user identifier.

11. The method of claim 10, wherein the transaction request further includes a quantity identifier associated with the transaction.

12. The method of claim 10, wherein the first user mobile device is disposed in a different country than the second user mobile device.

13. The method of claim 12, wherein the first mobile network operator does not operate in the country where the second user mobile device is located.

14. The method of claim 10, wherein determining whether an account associated with the first user identifier includes sufficient funds further comprises:
requesting, via the digital communication network, confirmation from a third party payment provider that the account associated with the first user identifier includes sufficient funds and;
receiving confirmation from the third party payment provider that the account associated with the first user identifier includes sufficient funds.

15. The method of claim 14, further comprising requesting, via the digital communication network, that the third party payment provider transfer funds from the account associated with the first user identifier to the account associated with the second user identifier.

16. The method of claim 10, further comprising transmitting to the first user mobile device, via the digital communication network, a message indicating that the transaction is cancelled if no confirmation is received within a predetermined time.

17. A non-transitory machine readable storage medium storing machine-executable instructions for causing a processor to perform a method for conducting a transaction between two parties, the method comprising:
receiving, from a first user mobile device via a digital communication network, a first user identifier that identifies a first party of two parties to a transaction for a product;
receiving, from the first user mobile device, a transaction request associated with the first user identifier, the transaction request including i) a product identifier that identifies a product to be transacted between the two parties, ii) a price indicator that includes the price of the product, and iii) a second user identifier that is associated with a second user mobile device and identifies a second party of the two parties to the transaction, wherein the first user mobile device and the second user mobile device operate via different mobile network operators;
transmitting, to the second user mobile device, a request for confirmation of the transaction that includes the product identifier and the price indicator;
in response to receiving a confirmation from the second user mobile device, determining whether an account associated with the first user identifier includes sufficient funds; and
transferring an amount from the account associated with the first user identifier to an account associated with the second user identifier if the account associated with the first user is determined to include sufficient funds.

18. The method of claim 17, wherein determining whether an account associated with the first user identifier includes sufficient funds further comprises:
requesting, via the digital communication network, confirmation from a third party payment provider that the account associated with the first user identifier includes sufficient funds and;
receiving confirmation from the third party payment provider that the account associated with the first user identifier includes sufficient funds.

19. The method of claim 18, further comprising requesting, via the digital communication network, that the third party payment provider transfer funds from the account associated with the first user identifier to the account associated with the second user identifier.

20. The method of claim 17, further comprising transmitting to the first user mobile device, via the digital communication network, a message indicating that the transaction is cancelled if no confirmation is received within a predetermined time.
